(19) United States
(12) Patent Application Publication
(10) Pub. No.: US 2005/0126014 A1
(43) Pub. Date: Jun. 16, 2005

(54) Cutting device with integral spring and lock screw

(76) Inventors: Mohammed Yamin, Denville, NJ (US); Barry William Miller, Garden City, NY (US)

Correspondence Address: STEVEN B. STEIN, ESQ.;STEIN & STEIN, 114 OLD BLOOMFIELD AVENUE, PARSIPPANY, NJ, 07054, US

(21) Appl. No.: 10/991,761

(22) Filed: Nov. 18, 2004

Related U.S. Application Data
(60) Provisional application No. 60/529,130, filed on Dec. 11, 2003.

(51) Int. Cl. B26B 3/06

(52) U.S. Cl. 30/254

(57) ABSTRACT

The present invention relates generally to the field of cutting devices and specifically relates to cutting tools comprising a locking means in the form of an integral screw. In particular, the invention relates to a cutting device comprising an integral spring, capable of facilitating opening of the blades. According to one embodiment of this invention, the device comprises a locking screw and spring in scissors and nippers. According to an embodiment of this invention, the blades are self-sharpening.

The present application claims priority to Provisional Application Ser. No. 60/529,130, filed on Dec. 11, 2003, which is hereby incorporated by reference in its entirety.

### FIELD OF THE INVENTION

The present invention relates generally to the field of cutting devices and specifically relates to cutting tools comprising a locking means in the form of an integral screw. In particular, the invention relates to a cutting device comprising an integral spring, capable of facilitating opening of the blades. According to a preferred embodiment of this invention, the device comprises a locking screw and integral spring in scissors, clippers and nippers. According to the preferred embodiment, the blades are self-sharpening.

### BACKGROUND OF THE INVENTION

Cutting implements and tools have long been in use for cutting hair, cloth, plants, paper, and other materials. Cutting tools are more efficient where the user only needs to use one hand to manipulate the device. Thus the other hand is free to hold or guide the material during the cutting process. Thus, cutting tools were formed that had blades pivotally attached with handles. Specifically, scissor handles often have finger and thumb loops while clippers, shears and nippers have handles that are operated by the thumb and a gripping motion. To manipulate the scissors and nippers they must be manually opened and closed upon the object to be cut. Thus a need exists for a cutting device that is capable of self-opening after each cut to facilitate the cutting process.

Repetitive motions such as cutting using cutting devices such as scissors, shears, clippers or nippers are an identifiable cause of carpal tunnel syndrome in some users. A device, which relieves the stress caused by the repetitive opening and closing motion is therefore very desirable. The spring action of the present invention solves this problem.

Cutting devices, particularly for use in manicures and pedicures have been described. (U.S. Pat. No. 5,722,171; U.S. Pat. No. 3,651,573; and U.S. Pat. No. 4,299,030). Cutting tools contain sharp blades. Therefore, they can be very dangerous is left in an open position with the cutting surface exposed. Cutting tools with a blade lock have been described. (U.S. Pat. No. 3,651,573; U.S. Pat. No. 4,452,246; and U.S. Pat. No. 4,567,656). However, the previously described locking mechanisms described are relatively difficult to manipulate, not completely reliable in operation and only work on a specific type of cutting implement. They often operate by affecting a change in the tension, or tightness between the blades or they represent an external lock mechanism. Thus, a need exists for an integral locking means that is easily manipulated, reliable and works on many types of cutting devices and is independent of blade tension.

The present invention provides distinct advantages over the prior art and solves numerous problems long described and understood in the field.

### SUMMARY OF THE INVENTION

It is therefore an object of this invention to provide a cutting device comprising (a) a first cutting blade, the blade comprising a first blade inside surface; a first blade outside surface; a first handle end portion; a first blade portion, the first blade end portion extending away from the first handle end portion and terminating at a first blade tip, the first blade portion having a first blade cutting edge and an opposing first blade blunt edge; (b) a second cutting blade, the blade comprising a second blade inside surface; a second blade outside surface; a second handle end portion; a second blade portion, the first blade end portion extending away from the second handle end portion and terminating at a second blade tip, the second blade portion having a second blade cutting edge and an opposing second blade blunt edge; (c) an articulating insert means for pivotally connecting the first cutting blade and the second cutting blade at an intersection portion location whereby the first cutting blade and the second cutting blade are movable between an open position where the first cutting blade and the second cutting blade are oriented transversely to each other, and a closed position wherein the first cutting blade and the second cutting blade are oriented alongside each other, the intersection portion further comprising an integral locking screw means for securing the first cutting blade and the second cutting blade in the closed position; and (d) an integral spring means for facilitating moving the first cutting blade and the second cutting blade into the open position.

### BRIEF DESCRIPTION OF THE FIGURES

FIG. 1 shows a front view of a first cutting blade 101 and a second cutting blade 201.

FIG. 2 shows a front view of a first cutting blade 101 and a second cutting blade 201 joined together in the form of scissors.

FIG. 3 shows an embodiment of the present invention in the form of short blade scissors in (3A) front view of closed position, (3B) side view, (3C) front view of open position. The locking screw 403 is also shown.

FIG. 4 shows an embodiment of the present invention in the form of blunt tip blade scissors in (4A) front view of closed position, (4B) side view, (4C) front view of open position. The locking screw 403 is also shown.

FIG. 5 shows an embodiment of the present invention in the form of short curved fine tip blade scissors in (5A) front view of closed position, (5B) side view, (5C) front view of open position. The locking screw 403 is also shown.

FIG. 6 shows an embodiment of the present invention in the form of barber scissors with curved finger hold in (6A) front view of closed position, (6B) side view, (6C) front view of open position. The locking screw 403 is also shown.

FIG. 7 shows an embodiment of the present invention in the form of short curved blade scissors in (7A) front view of closed position, (7B) side view, (7C) front view of open position. The locking screw 403 is also shown.

FIG. 8 shows an embodiment of the present invention in the form of short blade cuticle nippers in (8A) front view of closed position, (8B) side view, (8C) front view of open position. The locking screw 403 is also shown.

FIG. 9 shows an embodiment of the present invention in the form of nail clippers in (9A) front view of closed position, (9B) side view, (9C) front view of open position. The locking screw 403 is also shown.

FIG. 10 shows an embodiment of the present invention in the form of nail clippers with barrel spring 601 positioned between the handle ends in (10A) front view of closed position, (10B) side view, (10C) front view of open position. The locking screw 403 is also shown.

### DETAILED DESCRIPTION OF THE INVENTION

The present invention provides a cutting device comprising (a) a first cutting blade, the blade comprising a first blade inside surface; a first blade outside surface; a first handle end portion; a first blade portion, the first blade end portion extending away from the first handle end portion and terminating at a first blade tip, the first blade portion having a first blade cutting edge and an opposing first blade blunt edge; (b) a second cutting blade, the blade comprising a second blade inside surface; a second blade outside surface; a second handle end portion; a second blade portion, the first blade end portion extending away from the second handle end portion and terminating at a second blade tip, the second blade portion having a second blade cutting edge and an opposing second blade blunt edge; (c) an articulating insert means for pivotally connecting the first cutting blade and the second cutting blade at an intersection portion location whereby the first cutting blade and the second cutting blade are movable between an open position where the first cutting blade and the second cutting blade are oriented transversely to each other, and a closed position wherein the first cutting blade and the second cutting blade are oriented alongside each other, the intersection portion further comprising an integral locking screw means for securing the first cutting blade and the second cutting blade in the closed position; and (d) an integral spring means for facilitating moving the first cutting blade and the second cutting blade into the open position.

According to one embodiment of the invention, the first cutting blade further comprises a first blade spring channel. According to an embodiment of this invention, the integral spring means is positioned in at least a portion of the first blade spring channel. According to still another embodiment of this invention, the integral spring means contacts the second cutting blade. According to yet another embodiment of this invention, the second cutting blade further comprises a second blade spring channel. According to still yet another embodiment of this invention, the integral spring means is positioned in at least a portion of the first blade spring channel and in at least a portion of the second spring channel.

Another embodiment of the present invention provides the cutting device, wherein the articulating insert means is located approximately at the midpoint of the cutting blade. According to still another embodiment of this invention, the articulating insert means is located approximately between the midpoint and the blade end. Still, according to another embodiment of the present invention, the first cutting blade further comprises a first blade aperture in the intersection portion, extending through the first blade outside surface and the first blade inside surface. Further, according to another embodiment of this invention, the second cutting blade further comprises a second blade aperture in the intersection portion, extending through the second blade inside surface, capable of aligning with the first blade aperture when the cutting device is positioned in the closed position. According to a further embodiment of the present invention, the aperture is threaded. The present invention also provides an embodiment wherein the articulating insert means is a screw. According to an embodiment of this invention, the screw extends through the aperture in the first blade into the aperture in the second blade. According to a preferred embodiment of this invention, the integral screw is non-removable. According to another preferred embodiment of this invention, the articulating insert is non-removable. According to yet another preferred embodiment of this invention, the integral spring is a leaf spring. According to still another embodiment, the integral spring is a tension spring. According to an alternative embodiment, the integral spring is a coil spring. According to a further embodiment of the present invention, the cutting blades are self-sharpening. It is specifically contemplated that the frictional action between the operating cutting blade effects self-sharpening.

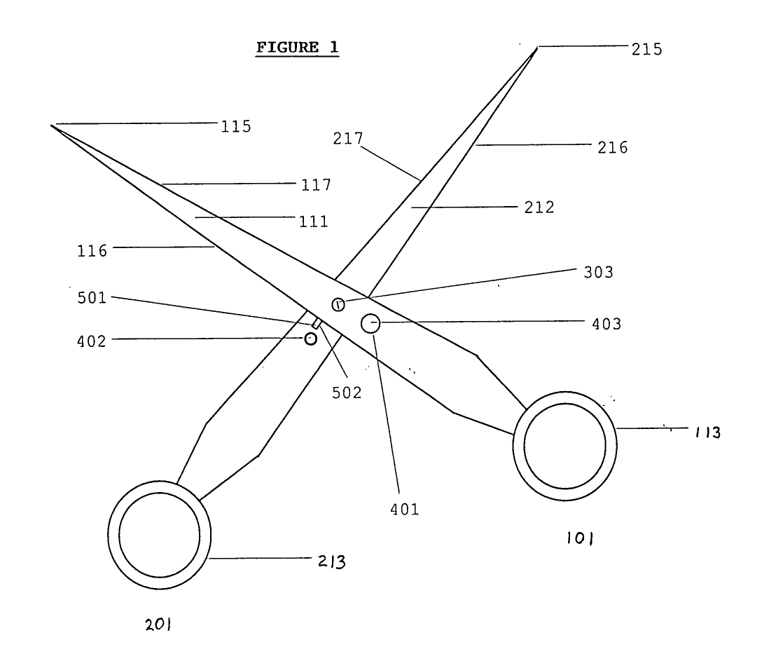

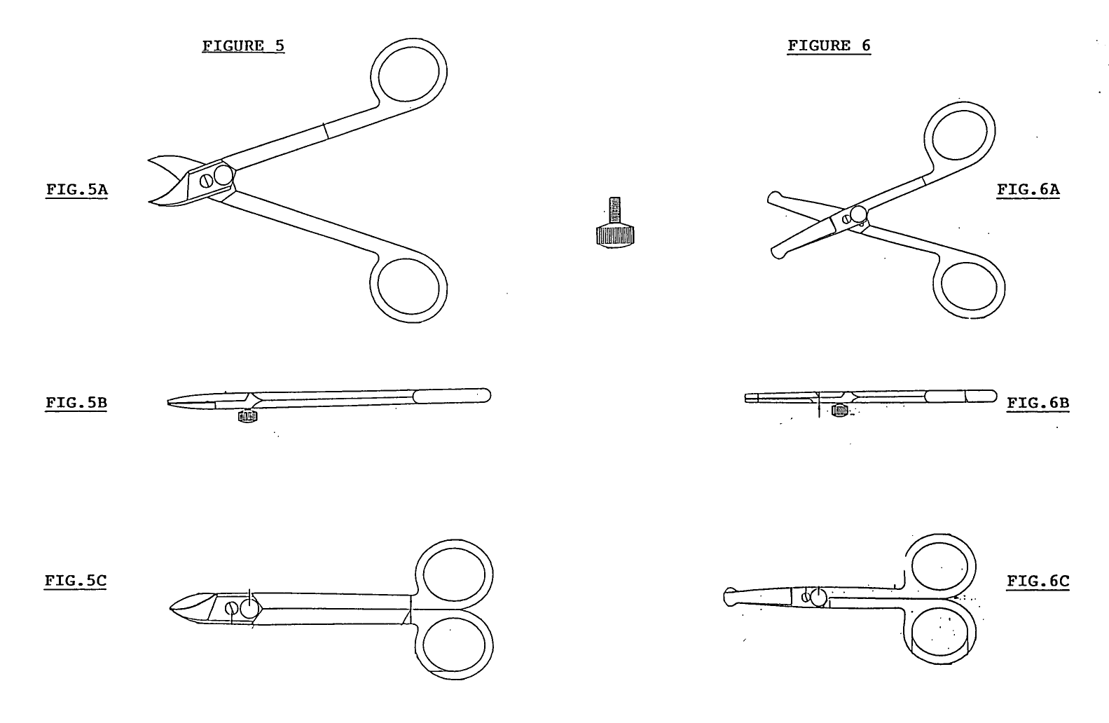

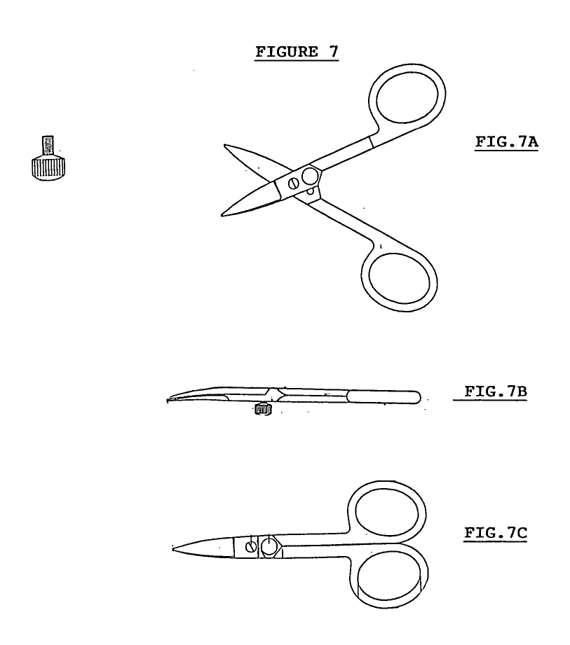

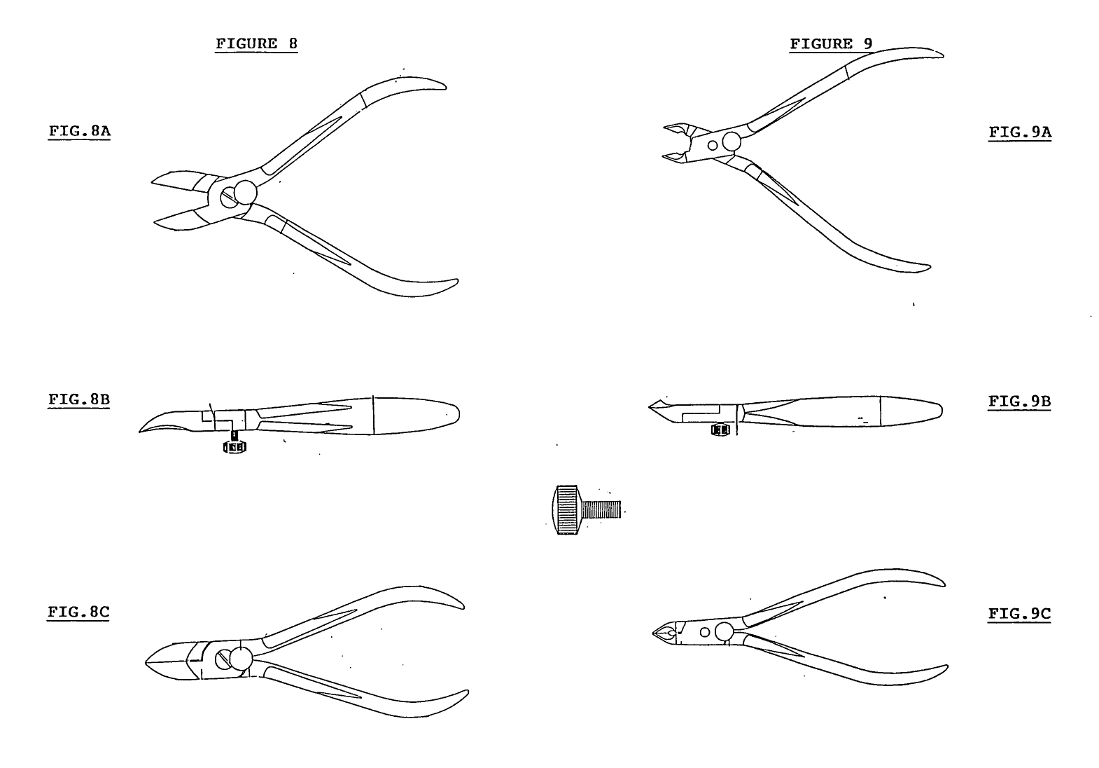

Turning now to the figures, FIG. 1 shows an embodiment of the present invention in the form of scissors, showing a first cutting blade 101, a second cutting blade 102. The figure shows the device in the open position with the first cutting blade 101 joined to the second cutting blade 102. It is specifically contemplated that the provided device may take numerous forms including but not limited to scissors, shears, shears, nippers and clippers, examples of which are shown in FIGS. 1-10. Turning again to FIG. 1, the first cutting blade 101 is comprising a first blade inside surface 111 and a first blade outside surface 112. The inside surface of the first cutting blade faces an opposing second cutting blade inside surface. The first cutting blade 101 further comprises a first handle end portion 113, which in the embodiment shown in FIG. 1 terminates in a circular loop, convenient for inserting a finger such as a thumb or forefinger in order to facilitate movement of the first cutting blade 101 relative to a second cutting blade 201. The first cutting blade further comprises a first blade portion 114, which extends away from the first handle end portion 113 and terminates at a first blade tip 115. According to the embodiment shown in FIG. 1, the first blade tip tapers to a sharp point. According to other embodiments, there is no tapering. Moreover, it is specifically contemplated that according other embodiments the first blade tip is blunt or rounded in shape. Indeed the blade tip may incorporate a variety of different shapes and curves. The first blade portion 114 has a first blade cutting edge 116, which is sharp and acts as the cutting surface, when in contact with a second blade cutting edge 216. The first blade portion 114 also has a first blade blunt edge 117 on the side of the first blade portion opposite from the first blade cutting edge.

FIG. 1 further shows a second cutting blade 201, the blade comprising a second blade inside surface 211; a second blade outside surface 212; a second handle end portion 213; a second blade portion 214, the first blade end portion 214 extending away from the second handle end portion 213 and terminating at a second blade tip 215, the second blade portion 214 having a second blade cutting edge 216 and an opposing second blade blunt edge 217.

The first cutting blade and the second cutting blade are each preferably comprised of stainless steel, but may be comprised of other metals including but not limited to aluminum, titanium, copper and brass. Alternatively, the first cutting blade and the second cutting blade each may be comprised of composite materials or plastic. According to the most preferred embodiment, the first cutting blade and the second cutting blade are made of hardened steel of a 420J1 hardness grade.

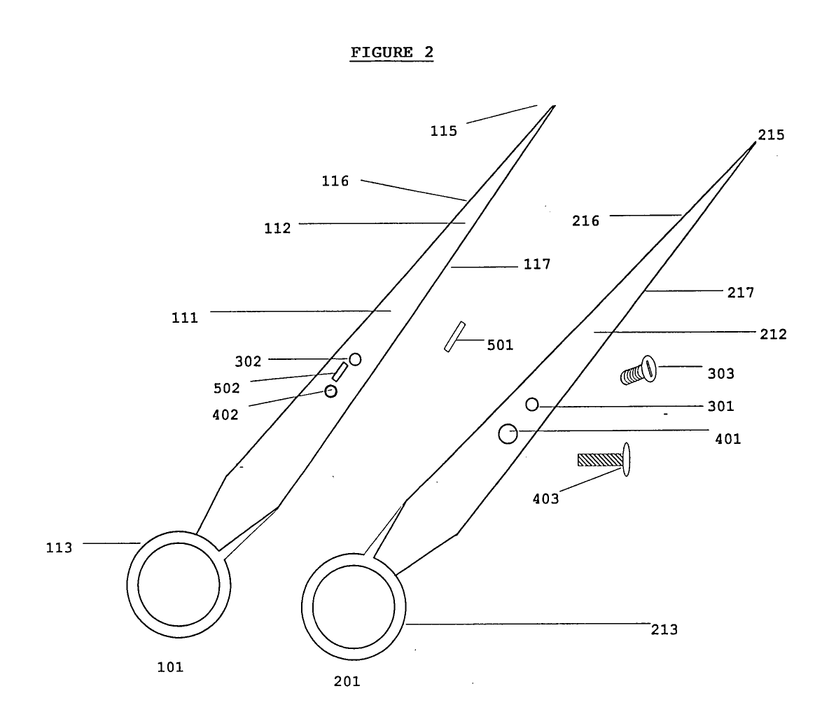

Turning to FIG. 2, the first cutting blade 101 and the second cutting blade 201 are connected to each other transversely by an articulating insert means 303. The articulating insert means 303 pivotally connects through a first intersection portion aperture 301 of the first cutting blade 101 and the second cutting blade 201 at a second intersection portion location 302 whereby the first cutting blade 101 and the second cutting blade 102 are movable between an open position where the first cutting blade 101 and the second cutting blade 201 are oriented transversely to each other, and a closed position wherein the first cutting blade 101 and the second cutting blade 201 are oriented alongside each other. According to this embodiment, the articulating insert means is a rivet, closed on each side and non-removable. The present invention specifically contemplates that the articulating insert means may be a screw, a nut, a lock washer, a bolt, a pin, a screw post or any other fastening device that would permit relative motion between the first cutting blade and the second cutting blade. The articulating insert means is preferably comprised of stainless steel, but may be comprised of other metals including but not limited to aluminum, titanium, copper and brass. Alternatively, the articulating insert means may be comprised of composite materials or plastic.

The intersection portion further comprising an integral locking screw means 403 for securing the first cutting blade 101 and the second cutting blade 201 in the closed position. According to the exemplified embodiment, the integral locking screw is a threaded screw. According to this embodiment, the integral locking screw means 403 is inserted through a first locking screw aperture 401 in the intersection portion of the first cutting blade and into a threaded receiving opening 402 in the intersection portion of the second cutting blade which aligns with the first cutting blade aperture when the blades are in a closed position. The integral locking screw means 403 can be rotated to screw the integral locking screw means 403 into the threaded receiving opening in the intersection portion of the second cutting blade, thereby locking the blades in a closed position and preventing movement of the blades from the closed position. The present invention specifically contemplates that the integral locking screw means may be in the form of a snap-lock, of a pin, of a latch, of a lever or of any other removable or quick release fastener. According to a preferred embodiment, the integral locking screw means is not completely removable from the device, thereby reducing the likelihood that the integral locking screw means will be lost or dropped during operation. The integral locking screw means is preferably comprised of stainless steel, but may be comprised of other metals including but not limited to aluminum, titanium, copper and brass. Alternatively, the integral locking screw means may be comprised of composite materials or plastic.

The invention further comprises an integral spring means 501 for facilitating moving the first cutting blade and the second cutting blade into the open position. According to a preferred embodiment the integral spring means is partially positioned within an integral spring canal 502 located on the first cutting blade and partially within a corresponding integral spring canal located on the second cutting blade, situated in such a way as to create tension pushing the first cutting blade tip away from the second cutting blade tip. According to a preferred embodiment, the integral spring means is a leaf spring. A leaf spring is a short, shaped element, which when compressed from end to end increases tension within the spring. According to the present invention, tension on the spring is increased when the first cutting blade and the second cutting blade are in the closed position. Without counter tension pushing the first cutting blade tip towards the second cutting blade tip, the integral spring means will push the tips apart. The integral locking screw means can prevent such opening when the integral locking screw means is fastened to the receiving opening when the device is in the closed position. According to a preferred embodiment of this invention, the integral spring is comprised of stainless steel, but may be comprised of other metals including but not limited to aluminum, titanium, copper and brass. Alternatively, the integral spring may be comprised of composite materials or plastic. According to a preferred embodiment, the integral spring is a leaf spring. However, the present invention specifically contemplates the use of any other spring, which can create tension inducing the tips to move towards the open position. Such spring types include but are not limited to coil springs, barrel springs, tension springs, compression springs, torsion springs, all of which are well known to one of skill in the art.

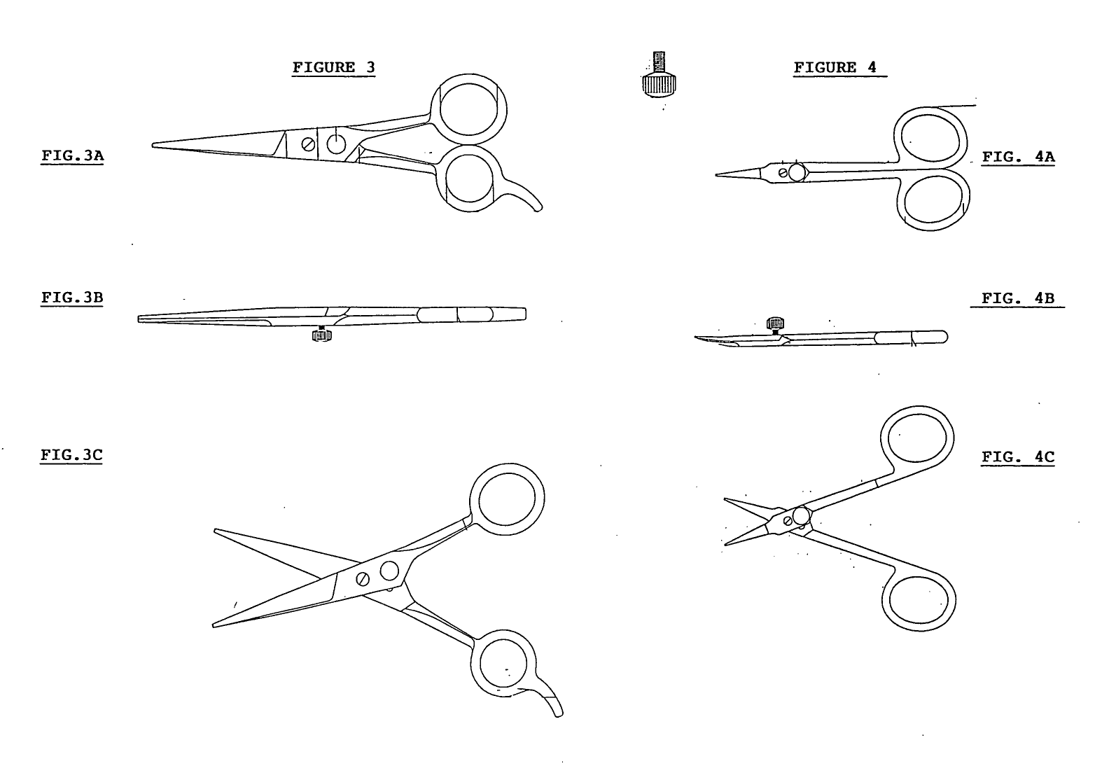

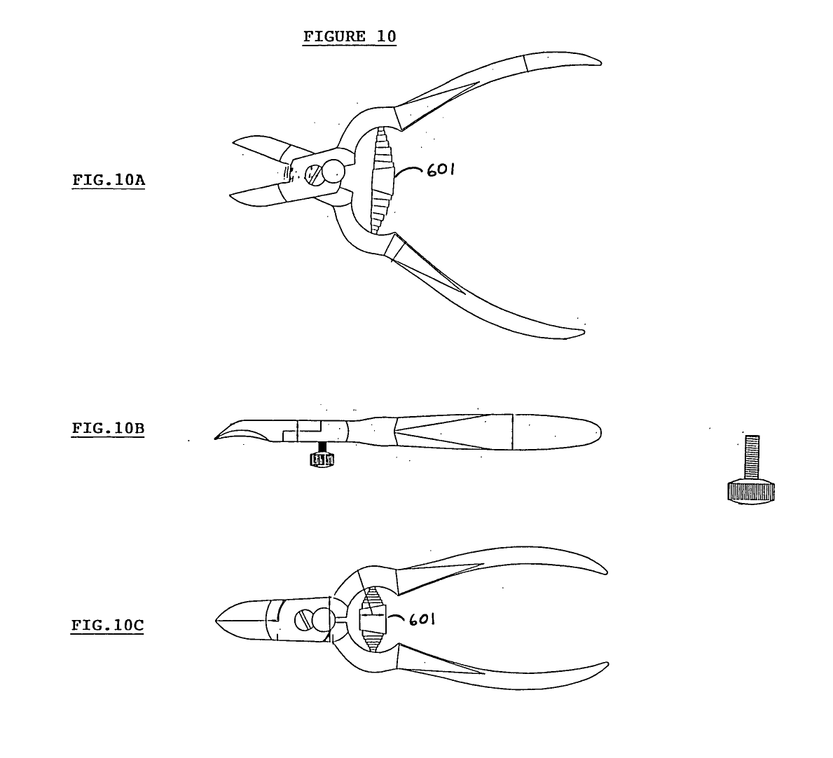

FIGS. 3-10 exemplify various forms of the provided device, including scissors, nippers and clippers. FIG. 10 shows clippers using a barrel spring, the barrel spring 601 situated between the handle ends of the opposing cutting blades, thereby facilitating opening under spring tension.

Throughout this application, various publications and patents and patent applications are referenced. The disclosures of these publications in their entireties are hereby incorporated by reference into this application in order to more fully describe the state of the art.

This invention may be embodied in other forms or carried out in other ways without departing from the spirit or essential characteristics thereof. The present disclosure is therefore to be considered as in all respects illustrative and not restrictive, the scope of the invention being indicated by the appended Claims, and all changes which come within the meaning and range of equivalency are intended to be embraced therein.

1. A cutting device comprising:
a. a first cutting blade, the blade comprising
i. a first blade inside surface;
ii. a first blade outside surface;
iii. a first handle end portion;
iv. a first blade portion, the first blade end portion extending away from the first handle end portion and terminating at a first blade tip, the first blade portion having a first blade cutting edge and an opposing first blade blunt edge;
b. a second cutting blade, the blade comprising
i. a second blade inside surface;
ii. a second blade outside surface;
iii. a second handle end portion;
iv. a second blade portion, the first blade end portion extending away from the second handle end portion and terminating at a second blade tip, the second blade portion having a second blade cutting edge and an opposing second blade blunt edge;
c. an articulating insert means for pivotally connecting the first cutting blade and the second cutting blade at an intersection portion location whereby the first cutting blade and the second cutting blade are movable between an open position where the first cutting blade and the second cutting blade are oriented transversely to each other, and a closed position wherein the first cutting blade and the second cutting blade are oriented alongside each other, the intersection portion further comprising an integral locking screw means for securing the first cutting blade and the second cutting blade in the closed position; and
d. an integral spring means for facilitating moving the first cutting blade and the second cutting blade into the open position.

2. The cutting device according to claim 1, wherein the first cutting blade further comprises a first blade spring channel.

3. The cutting device according to claim 2, wherein the integral spring means is positioned in at least a portion of the first blade spring channel.

4. The cutting device according to claim 3, wherein the integral spring means contacts the second cutting blade.

5. The cutting device according to claim 2, wherein the second cutting blade further comprises a second blade spring channel.

6. The cutting device according to claim 3, wherein the integral spring means is positioned in at least a portion of the first blade spring channel and in at least a portion of the second spring channel.

7. The cutting device according to claim 1, wherein the articulating insert means is located approximately at the midpoint of the cutting blade.

8. The cutting device according to claim 1, wherein the articulating insert means is located approximately between the midpoint and the blade end.

9. The cutting device according to claim 1, wherein the first cutting blade further comprises a first blade aperture in the intersection portion, extending through the first blade outside surface and the first blade inside surface.

10. The cutting device according to claim 1, wherein the second cutting blade further comprises a second blade aperture in the intersection portion, extending through the second blade inside surface, capable of aligning with the first blade aperture when the cutting device is positioned in the closed position.

11. The cutting device according to claim 9, wherein the aperture is threaded.

12. The cutting device according to claim 10, wherein the aperture is threaded.

13. The cutting device according to claim 1, wherein the articulating insert means is a screw.

14. The cutting device according to claim 13, wherein the screw extends through the aperture in the first blade into the aperture in the second blade.

15. The cutting device according to claim 1, wherein the integral screw is non-removable.

16. The cutting device according to claim 1, wherein the articulating insert is non-removable.

17. The cutting device according to claim 1, wherein the integral spring is a leaf spring.

18. The cutting device according to claim 1, wherein the integral spring is a tension spring.

19. The cutting device according to claim 1, wherein the integral spring is a coil spring.

20. The cutting device according to claim 1, wherein the cutting blades are self-sharpening.
